(19) United States
(12) Patent Application Publication
(10) Pub. No.: US 2006/0140490 A1
(43) Pub. Date: Jun. 29, 2006

(54) Method and apparatus for controlling access to image data

(76) Inventors: Anantharaman Balasubramanian, Tamilnadu (IN); Ashwin Amarapur Chandramouly, Karnataka (IN)

Correspondence Address: Kin-Wah Tong;Moser, Patterson & Sheridan, LLP, Suite 100, 595 Shrewsbury Ave., Shrewsbury, NJ, 07702, US

(21) Appl. No.: 11/025,268

(22) Filed: Dec. 29, 2004

(51) Int. Cl. G06K 9/36

(52) U.S. Cl. 382/232; 382/236

(57) ABSTRACT

Method and apparatus for controlling access to image data is described. In one example, a set of samples associated with said image data is frequency translated to produce coefficients. The coefficients are quantized. At least a first portion of the coefficients are shifted using first key data. At least a second portion of the coefficients are shuffled using scrambling table data. The coefficients are entropy coded to produce encoded image data. In this manner, security is provided for the image data without impacting compression efficiency. The coefficients may be organized into a plurality of levels. For each coefficient in the first portion of coefficients, a level of the plurality of levels for the coefficient is identified, and a magnitude of the coefficient is adjusted using a key associated with the identified level such that the coefficient remains in the identified level (i.e., intra-level shifted).

### BACKGROUND OF THE INVENTION

1. Field of the Invention

The present invention relates to image processing systems and, more particularly, to a method and apparatus for controlling access to image data.

2. Description of the Background Art

Intellectual property rights (IPR) management for image data is becoming increasingly important. Such image data includes still image data, such as joint photographic experts group (JPEG) data, as well as video data, such as motion JPEG (MJPEG) data, moving pictures experts group (MPEG) data, and H.263 data. Several techniques have been developed for restricting access to image data. The most direct method of restricting access to image data is to employ data encryption mechanisms. However, encrypting the image data adds enormous computational overhead that may become impractical for real time implementations. Furthermore, encryption and decryption of the image data adds latency to real time delivery.

Scrambling techniques have been used to provide content access control of image data. Scrambling techniques are better than encryption techniques in terms of computational overhead. However, present scrambling techniques exhibit an adverse impact on the compression efficiency. Notably, conventional scrambling techniques distort the statistical properties of the image data, which decreases the compression efficiency.

Accordingly, there exists a need in the art for a method and apparatus for controlling access to image data that exhibits reduced computational overhead and a reduced impact on compression efficiency.

### SUMMARY OF THE INVENTION

Method and apparatus for controlling access to image data is described. In one embodiment, a method and apparatus for encoding image data is disclosed. A set of samples associated with said image data is frequency translated to produce coefficients. The coefficients are quantized. At least a first portion of the coefficients are shifted using first key data. At least a second portion of the coefficients are shuffled using scrambling table data. The coefficients are entropy coded to produce encoded image data. In this manner, the present invention provides security for the image data without impacting compression efficiency. In one embodiment, the coefficients are organized into a plurality of levels, and the first key data includes a key for each of the plurality of levels. For each coefficient in the first portion of coefficients, a level of the plurality of levels for the coefficient is identified, and a magnitude of the coefficient is adjusted using the key associated with the identified level such that said coefficient remains in the identified level (i.e., intra-level shifted). In another embodiment, motion vectors a produced from the image data and each of the motion vectors is also shifted using second key data.

In another embodiment, a method and apparatus for decoding encoded image data is disclosed. Encoded image data is entropy decoded to produce quantized coefficients. First key data and scrambling table data associated with the encoded image data is obtained. The quantized coefficients are inverse quantized to recover coefficients. At least a first portion of the coefficients are de-shuffled using the scrambling table data. At least a second portion of the coefficients are shifted using the first key data. The coefficients are frequency translated to produce a set of image data samples.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a JPEG compliant encoder constructed in accordance with the invention;

FIG. 2 is a flow diagram depicting an exemplary embodiment of a method for encoding image data in accordance with the invention;

FIG. 3 is a block diagram depicting an exemplary embodiment of a JPEG compliant decoder constructed in accordance with the invention;

FIG. 4 is a flow diagram depicting an exemplary embodiment of a method for decoding encoded image data in accordance with the invention;

FIG. 5 is a block diagram depicting an exemplary embodiment of an MPEG compliant encoder constructed in accordance with the invention;

FIG. 6 is a flow diagram depicting an exemplary embodiment of a method for controlling access to image data in accordance with the invention;

FIG. 7 is a block diagram depicting an exemplary embodiment of an MPEG compliant decoder constructed in accordance with the invention;

FIG. 8 is a flow diagram depicting an exemplary embodiment of a method 800 for decoding encoded image data using the decoder of FIG. 7 in accordance with the invention; and

FIG. 9 is a block diagram depicting an exemplary embodiment of a computer suitable for implementing the processes and methods described herein.

To facilitate understanding, identical reference numerals have been used, where possible, to designate identical elements that are common to the figures.

### DETAILED DESCRIPTION OF THE INVENTION

A method and apparatus for controlling access to image data is described. The present invention is capable of providing security for image data without impacting compression efficiency. Notably, the present invention provides two layers of security: (1) at least a portion of the frequency transform coefficients are intra-level shifted using key data; and (2) at least a portion of the frequency transform coefficients are shuffled using scrambling table data. One aspect of the invention relates to controlling access to joint photographic experts group (JPEG) encoded image frames or a motion JPEG (MJPEG) stream of image frames. Another aspect of the invention relates to controlling access to moving pictures experts group (MPEG) encoded video streams or H.263 encoded video streams. The term “image data,” as used herein, is meant to encompass an image or images encoded in accordance with JPEG, MJPEG, MPEG, H.263, and like type image encoding standards known in the art.

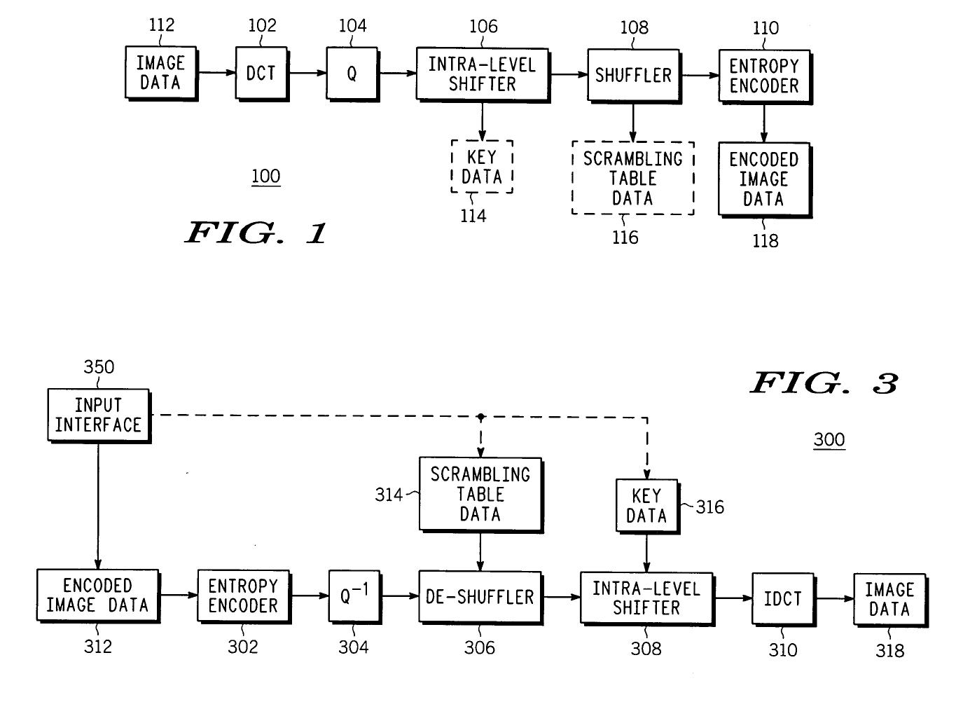

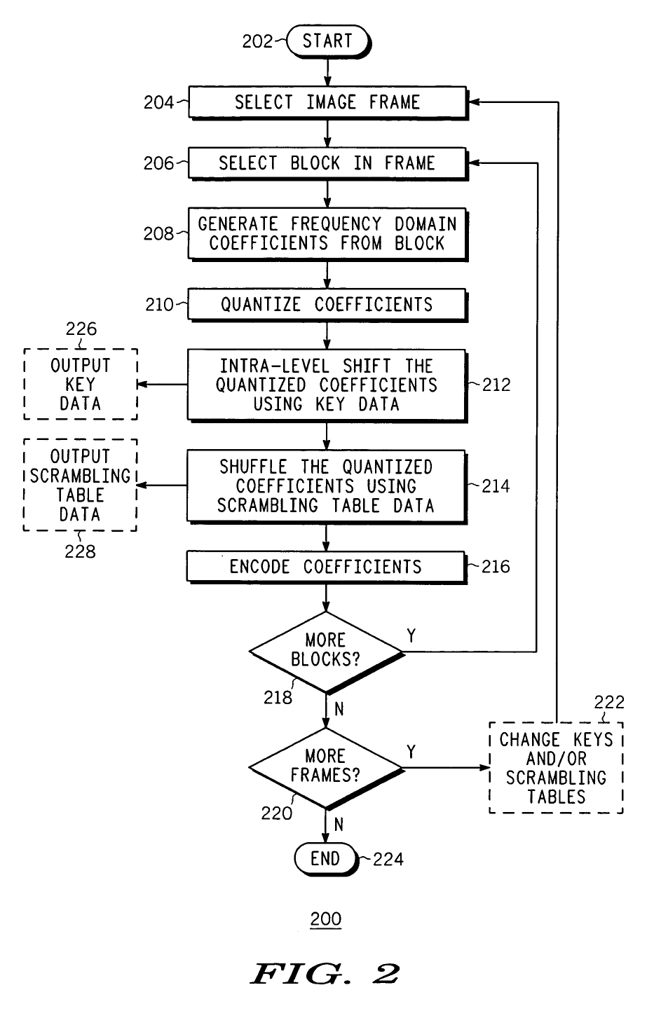

FIG. 1 is a block diagram depicting an exemplary embodiment of a JPEG compliant encoder 100 constructed in accordance with the invention. The encoder 100 is configured to process image data 112 to produce JPEG or MJPEG encoded image data 118. The encoder 100 comprises a discrete cosine transform (DCT) unit 102, a quantizer (Q) 104, an intra-level shifter 106, a shuffler 108, and an entropy encoder 110. An input port of the DCT unit 102 is configured to receive the input image data 112. An output port of the DCT unit 102 is coupled to an input port of the quantizer 104. An output port of the quantizer 104 is coupled to an input port of the intra-level shifter 106. Another output port of the intra-level shifter 106 may be configured to provide key data 114. An output port of the intra-level shifter 106 is coupled to an input port of the shuffler 108. Another output port of the shuffler 108 may be configured to provide scrambling table data 116. An output port of the shuffler 108 is coupled to an input port of the entropy encoder 110. An output port of the entropy encoder 110 is configured to provide the encoded image data 118. Operation of the image encoder 100 may be understood with reference to the image encoding method described below with respect to FIG. 2.

FIG. 2 is a flow diagram depicting an exemplary embodiment of a method 200 for encoding image data in accordance with the invention. The method 200 begins at step 202. At step 204, an image frame is selected from the image data 112. Notably, the image data 112 may comprise a single JPEG encoded frame or a sequence of JPEG frames that form an MJPEG stream. At step 206, a block of samples is selected in the frame. In the JPEG, blocks are 8 samples by 8 samples. At step 208, the DCT unit 102 generates frequency domain coefficients (DCT coefficients). The frequency domain coefficients include a DC coefficient and a plurality of AC coefficients, as is well known in the art. At step 210, the quantizer 104 quantizes the frequency domain coefficients produced by the DCT unit 102 to produce quantized coefficients.

At step 212, the intra-level shifter 106 intra-level shifts the quantized coefficients using key data. Notably, the quantized coefficients are processed to form symbols (also referred to as code words) at the encoder 110. The quantized coefficients are separated into a plurality of levels based on magnitude. The number of bits assigned to a quantized coefficient to form a symbol is based on the level in which the quantized coefficient belongs. For example, in the JPEG standard, the quantized coefficients may be potentially separated into 16 levels. Coefficients on the same level are assigned the same number bits. Table 1 illustrates the level organization for DC coefficients as set forth in the JPEG standard.

TABLE 1

| Size | Value |
|---|---|
| 1 | −1, 1 |
| 2 | −3, −2, 2, 3 |
| 3 | −7 . . . −4, 4 . . . 7 |
| 4 | −15 . . . −8, 8 . . . 15 |
| 5 | −31 . . . −16, 16 . . . 31 |
| 6 | −63 . . . −32, 32 . . . 63 |
| 7 | −127 . . . −64, 64 . . . 127 |
| 8 | −255 . . . −128, 128 . . . 255 |
| 9 | −511 . . . −256, 256 . . . 511 |
| 10 | −1023 . . . −512, 512 . . . 1023 |

The level organization for AC coefficients is similar to that of the DC coefficients with the addition of run-length encoding. Thus, the number of bits assigned to a non-zero AC coefficient depends on the number of zero AC coefficients preceding the non-zero AC coefficient and on the level to which the non-zero AC coefficient belongs. Notably, the total number of bits assigned to a non-zero AC coefficient is equal to the size of a variable length code (VLC) word corresponding to the run of zero AC coefficients preceding the non-zero AC coefficient and the level of the non-zero AC coefficient plus the number of additional bits to signify the magnitude of the non-zero AC coefficient in that level.

It is important to preserve the size of the VLC word, as well as the level, of the AC coefficients to avoid adverse impact on compression efficiency. Hence, the intra-level shifter 112 does not disturb the runs of zero AC coefficients preceding non-zero AC coefficients. However, DC/AC coefficients on the same level can be modified without loss in compression efficiency.

In particular, let L denote the level to which an DC/AC coefficient belongs (i.e., L=0, 1, . . . , 15). The set of coefficients on a given level L is given by:
S_{L}={a₀, a₁, . . . , a_{M-1}, a_{M}, . . . a_{2M-1}},
where M=2^{L-1}. For example, the set of elements in level three is:
S₃={−7, −6, −5, −4, 4, 5, 6, 7},
as shown in Table 1 above. Let x₀ correspond to the index of the original coefficient that is to be intra-level shifted (assume that the set S_{L} is always indexed from 0 through 2^{L-1}). The index, xₙ, corresponding to the new coefficient is found by:
xₙ=(x₀+k_{L}) modulo 2^{L} (1),
where k_{L} is a key corresponding to the level L. Although k_{L} may be any integer, it is noted that only 2^{L} values of k_{L} are unique. The intra-level shifted coefficient is then S_{L}[xₙ]. The intra-level shifter 106 shifts the DC coefficient and each non-zero AC coefficient in accordance with Equation 1 using an appropriate key. At optional step 226, the intra-level shifter 106 outputs the key data 114 used to shift the coefficients. As described below, the key data 114 may be changed dynamically from frame-to-frame. The key data 114 may be encrypted before being transmitted to the decoder. By encrypting the key data 114, the invention is more robust against plain text attacks (i.e., unauthorized use of unencrypted key data). Notably, the encryption of the key data 144 may be done with very insignificant overhead, as there are few keys to transmit (e.g., 16 or less). Alternatively, the key data 114 may be fixed and thus it is not required to be output by the intra-level shifter 106.

At step 214, the shuffler 108 shuffles the shifted coefficients using scrambling table data. In JPEG, the DC coefficients are coded at the entropy encoder 110 separately from the AC coefficients. To provide an additional level of security apart from intra-level shifting of the DC/AC coefficients, the shuffler 108 shuffles the non-zero AC coefficients until a first run of zero AC coefficients is encountered using a scrambling table. In JPEG, there are totally 63 AC coefficients and thus a maximum of 63 scrambling tables are required of length 1 through 63, respectively. The particular scrambling table used by the shuffler 108 depends on the position of the first run of zero AC coefficients. In practice, lengths of more than 30 may not be encountered before a first zero run, and hence it may be sufficient to store scrambling tables of lengths up to 30. At optional step 228, the shuffler 108 outputs the scrambling table data 116 used to shuffle the non-zero AC coefficients. As described below, the scrambling table data 116 may be dynamically changed from frame-to-frame. Alternatively, the scrambling table data 116 may be fixed and thus it is not required to be output from the shuffler 108. The scrambling table data 116 is used at a decoder to de-shuffle the coefficients, as described below. The scrambling table data 116 may be encrypted before being transmitted to the decoder. By encrypting the scrambling table data 116, the invention is more robust against plain text attacks (i.e., unauthorized use of unencrypted key data).

At step 216, the entropy encoder 110 encodes the shifted and shuffled coefficients in a well known manner to produce the encoded image data 118. At step 218, a determination is made as to whether there are more blocks to be processed in the currently selected image frame. If so, the method 200 returns to step 206 to select and process another block. Otherwise, the method 200 proceeds to step 220. At step 220, a determination is made as to whether there are more image frames to be processed. If so, the method 200 returns to step 204 to select and process another image frame. Otherwise, the method 200 ends at step 224. In this manner, the encoder 100 is configured to provide the encoded image data 118 along with the associated key data 114 and scrambling table data 116 as output.

The security provided by the invention can be analyzed as follows. Let l be the different DC/AC levels that occur in an image frame. Let t denote different lengths of tables in scrambling the non-zero AC coefficients. There are 2^{l}! ways of arranging the coefficients in level l. The number of attempts that a hacker requires to get the descrambled image is given by:

$${\prod }_{i = min ( l )}^{max ( l )} ( {2}^{i} \cdot {2}^{i} ! ) \cdot {\prod }_{m = min ( t )}^{max ( t )} m ! . \qquad ( 2 )$$

For example, consider an encoded image exhibiting levels 1 through 8 and scrambling tables of lengths 1 through 15 and 17. Applying Equation 2, the required number of trials required to descramble this image would be 1.1×10¹¹⁸.

In one embodiment of the invention, the scrambling tables, the keys, or both may be changed dynamically from frame-to-frame to make the invention more robust to plain text attacks. Thus, the method 200 may proceed from step 220 to optional step 222. At step 222, the key data and/or scrambling table data used by the intra-level shifter 106 and/or the shuffler 108 may be modified. Changing the 63 scrambling tables dynamically and transmitting them, however, involves significant overhead. Thus, in one embodiment, the scrambling table data 116 is fixed and is not transmitted to the decoder. However, as there are only 16 coefficient levels, the keys for all the levels that occur in a frame can be dynamically changed and transmitted. For example, the key for all coefficient levels can be changed every frame in an MJPEG stream. Since 0≦k_{L}≦2^{L}, only L bits are required to transmit the key. Hence, the overhead for transmitting the keys for all levels in a frame is:

$$T = {\sum }_{i = min ( l )}^{max ( l )} i . \qquad ( 3 )$$

The maximum value of T occurs when all the levels occur in a frame (l varying from 1 through 15), which is 120 bits. Thus, the keys for the levels may be changed dynamically from frame to frame, encrypted, and transmitted to a decoder to make the invention more robust to plain text attacks.

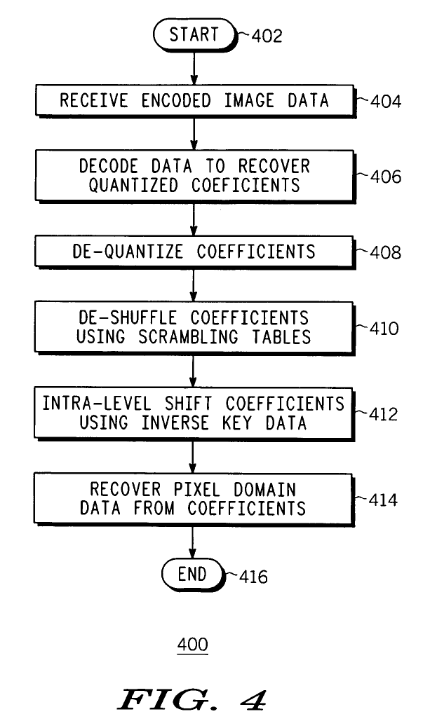

FIG. 3 is a block diagram depicting an exemplary embodiment of a JPEG compliant decoder 300 constructed in accordance with the invention. The decoder 300 is configured to process JPEG or MJPEG encoded image data 312 to recover image data 318. The decoder 300 comprises an entropy decoder 302, an inverse quantizer (Q⁻¹) 304, a de-shuffler 306, an intra-level shifter 308, an inverse DCT unit (IDCT) 310, and an input interface 350. The input interface 350 is configured to provide encoded image data 312, as well as scrambling table data 314 and/or key data 316, if such data is transmitted with the image data 312. An input port of the entropy decoder 302 is configured to receive the encoded image data 312. An output port of the entropy decoder 302 is coupled to an input port of the inverse quantizer 304. An output port of the inverse quantizer 304 is coupled to an input port of the de-shuffler 306. In one embodiment, another input port of the de-shuffler 306 is configured to receive the scrambling table data 314 associated with the encoded image data 312. Alternatively, the scrambling table data 314 may be fixed and known a-priori by the de-shuffler 306. An output port of the de-shuffler 306 is coupled to an input port of the intra-level shifter 308. In one embodiment, another input port of the intra-level shifter 308 is configured to receive the key data 316 associated with the encoded image data 312. Alternatively, the key data 316 may be fixed and known a-priori by the intra-level shifter 308. An output port of the intra-level shifter 308 is coupled to the IDCT unit 310. An output port of the IDCT unit 310 is configured to provide the image data 318. Operation of the image decoder 300 may be understood with reference to the image decoding method described below with respect to FIG. 4.

FIG. 4 is a flow diagram depicting an exemplary embodiment of a method 400 for decoding encoded image data in accordance with the invention. The method 400 begins at step 402. At step 404, the encoded image data 312, the scrambling table data 314, and the key data 316 are received at the decoder 300. At step 406, the entropy decoder 302 decodes the encoded image data 312 in a well know manner to recover quantized coefficients. At step 408, the inverse quantizer 304 de-quantizes the quantized coefficients. At step 410, the de-shuffler 306 uses the scrambling table data 314 to reverse the shuffling that was performed by the shuffler 108 in the encoder 100 of FIG. 1.

At step 412, the intra-level shifter 308 uses the key data 316 to reverse the intra-level shifting that was performed by the intra-level shifter 106 in the encoder 100 of FIG. 1. In particular, the intra-level shifter 308 processes the coefficients using the key data. An index within a level for an original coefficient (x₀) may be obtained from the index within a level of an intra-level shifted coefficient (xₙ) using the equation:
x₀=(xₙ−k_{L}) modulo 2^{L} (4),
where k_{L} is the key corresponding to the level L. At step 414, the IDCT unit 310 translates the frequency domain coefficients to the pixel domain to provide the image data 318. The method 400 ends at step 416.

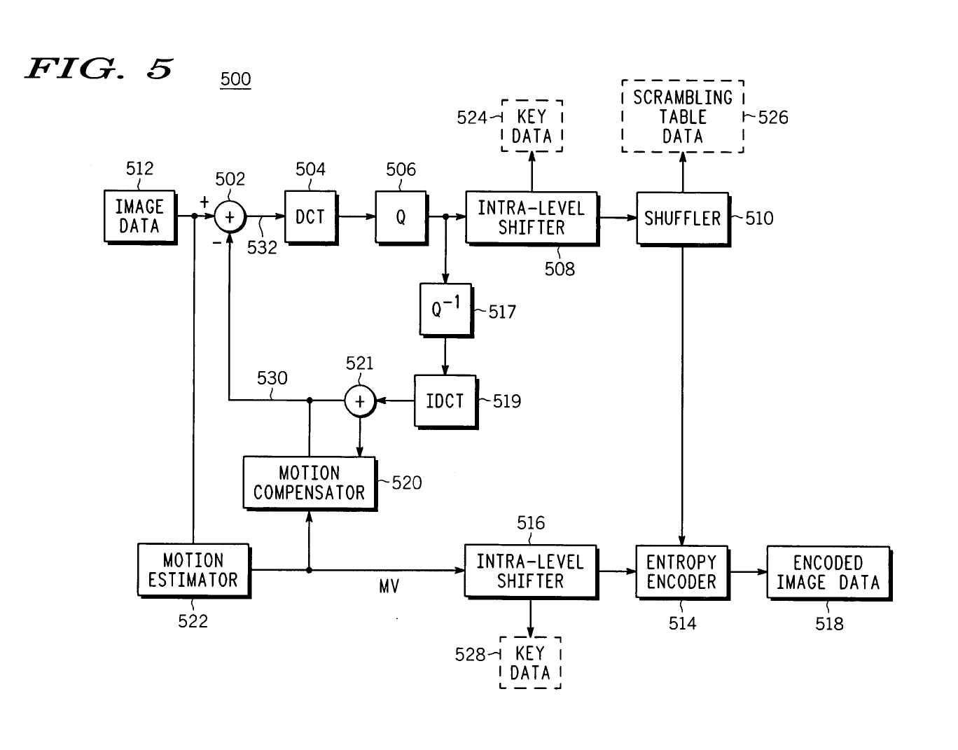

The access control mechanism of the invention may be modified to suit H.263/MPEG standards. In particular, FIG. 5 is a block diagram depicting an exemplary embodiment of an MPEG compliant encoder 500 constructed in accordance with the invention. The encoder 500 is configured to process image data 512 to produce MPEG encoded image data 518. The encoder 500 illustratively comprises a motion estimator 522, a subtractor 502, a DCT unit 504, a quantizer 506, a motion compensator 520, an inverse quantizer 517, a IDCT unit 519, and adder 521, an intra-level shifter 508, a shuffler 510, an entropy encoder 514, and an intra-level shifter 516. The image data 512 is divided into frames (pictures) represented by a plurality of macroblocks, where each macroblock comprises 8 sample by 8 sample blocks.

The motion estimator 522 is configured to receive the image data 512 and estimate motion vectors therefrom. As is well known in the art, a motion vector is a two-dimensional vector which is used by a motion compensator in a decoder to provide an offset from the coordinate position of a block in the current picture to the coordinates in a reference frame. The motion vectors from the motion estimator 522 are received by the motion compensator 520. The motion compensator 520 uses a previously decoded frame and the motion vectors to construct an estimate of the current frame. The motion compensator 520 generates a motion compensated prediction (predicted image) on path 530 of the contents of the block based on past and/or future reference frames. The predicted image on the path 530 is subtracted via the subtractor 502 from a macroblock in the image data 512 to form an error signal or predictive residual signal on path 532. It should be noted that if a current frame is encoded as an I-frame, then the signal on the path 532 is simply the original picture and not a predictive residual signal.

The DCT unit 504 is configured to process the predictive residual signal to produce frequency domain coefficients (DCT coefficients). Similar to the DCT unit in the JPEG compliant encoder above, the DCT unit 504 produces 64 coefficients per block (one DC coefficient and 63 AC coefficients). The quantizer 506 quantizes the coefficients to produce quantized coefficients. The quantized coefficients are received by the inverse quantizer 517. At this stage, the encoder 500 regenerates I-frames and P-frames by decoding the data so that they are used as reference frames for subsequent encoding. The resulting de-quantized coefficients are passed to the IDCT unit 519, which produces a decoded error signal. The decoded error signal is added back to the prediction signal from the motion compensator 520 via the summer 521 to produce a decoded reference picture (reconstructed image).

The quantized coefficients from the quantizer 506 are also processed by the intra-level shifter 508. Notably, the DC coefficients of the I-frames may be fixed length coded (e.g., as in the H.263/MPEG-4 simple profile). Similar to the JPEG standard, the DC coefficients are divided into twelve levels and the bits assigned to all the coefficients in the same level are equal. The original DC coefficients are intra-level shifted by using Equation (1) above. The AC coefficients may also be intra-level shifted to maximize scrambling, but with a loss in compression efficiency. Hence, depending on the trade-off allowed in the compression efficiency, a designer may choose to intra-level shift the AC coefficients. The intra-level shifter 508 may provide key data 524 for use by a decoder to recover the original coefficients. Alternatively, the key data 524 may be fixed and known a-priori by a decoder.

The motion vectors are processed by the intra-level shifter 516. Notably, the number of bits allocated to difference values of the motion vectors varies between 1 and 13. Thus, the motion vectors may be grouped according to the number of bits allocated thereto. That is, all the motion vectors having the same bit allocation are grouped in the same level. In MPEG-4, for example, there are a total of 10 difference levels (bit allocation). Let L denote the number of levels of motion vectors. Let N_{L} denote the number of motion vectors in level L. Let S_{L} denote the set of motion vectors in the level L. For example, the set of motion vectors (half-pel) that are allocated 13 bits is S₁₃={−32, −31, 31, 32}. The set of motion vectors that are allocated 12 bits is S₁₂={−30, −29, . . . , −25, 25, 26, . . . , 30}. Assuming that SL is indexed from 0 to N_{L}−1, the index, xₙ, of the modified motion vector is obtained from the index x₀ of the original motion vector by:
xₙ=(x₀+k_{L}) modulo N_{L} (5).

Thus, the intra-level shifted motion vector is S_{L}[xₙ]. It may be noted that k_{L} is an element of integers, but only N_{L} values of the key k_{L} are unique. Table 2 illustrates the motion vector prior to and after intra-level shift (assuming that the motion vectors in all levels are arranged in ascending order).

TABLE 2

| No. of Bits | Original Motion | Key | Intra-level Shifted |
|---|---|---|---|
| (Level) | Vector | (k_{L}) | Motion Vector |
| 13 | −32 | 3 | 31 |
| 12 | −27 | 9 | −30 |
| 11 | 22 | 16 | −11 |
| 11 | 11 | 30 | 13 |
| 8 | −6 | 5 | −7 |

The intra-level shifted motion vectors are provided to the entropy encoder 514. The intra-level shifter 516 may provide key data 528 for use by a decoder in recovering the original motion vectors. Alternatively, the key data 528 may be fixed and known a-priori by a decoder. The intra-level shifted coefficients output from the intra-level shifter 508 are provided to the shuffler 510. The shuffler 510 shuffles the non-zero AC coefficients until encountering a first run of zero-valued AC coefficients using scrambling table data. Shuffling the non-zero AC coefficients of the I-frames is usually more effective in creating randomness in video, than shuffling the non-zero AC coefficients of the P frames. However, the non-zero AC coefficients may be shuffled in either or both the I and P frames until the first run of zero-valued AC coefficients. The shuffler 510 may provide scrambling table data 526 for use by a decoder in de-shuffling the non-zero AC coefficients. Alternatively, the scrambling table data 526 may be fixed and known a-priori by a decoder. The entropy encoder 514 encodes the coefficients and the motion vectors in a well known manner to produce the encoded image data 518.

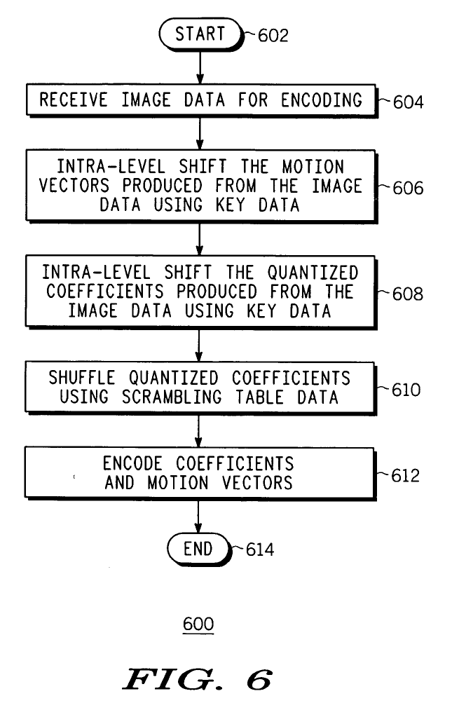

FIG. 6 is a flow diagram depicting an exemplary embodiment of a method 600 for controlling access to image data in accordance with the invention. Aspects of the method 600 may be understood with reference to FIG. 5. The method 600 begins at step 602. At step 604, the encoder 500 receives the image data 512 for encoding. At step 606, motion vectors produced by the motion estimator 522 from the image data 512 are intra-level shifted using key data. At step 608, the quantized coefficients produced by the quantizer 506 are intra-level shifted using key data. In one embodiment, only the DC coefficients in an I-frame are intra-level shifted. At step 610, the quantized coefficients are shuffled using scrambling table data. At step 612, the entropy encoder 514 encodes the quantized coefficients and the motion vectors to produce the encoded image data 518. The method 600 ends at step 614.

The analysis of security for the video case is the same with the JPEG embodiment described above, with the additional component of motion vectors taken in consideration. Let l denote different levels of DC coefficients, t denote different lengths of tables encountered in shuffling the non-zero AC coefficients until the first zero run, and k denote different levels of the motion vectors. Let Nⱼ denote the number of motion vectors in level j, and kⱼ denote the key used for intra-level shifting the motion vector in level j. It may be noted that the motion vectors in level j can be arranged in Nⱼ! ways. Hence, the number of attempts that a hacker needs to make to get a sequence of descrambled video is given by:

$${\prod }_{i = min ( l )}^{max ( l )} ( {2}^{i} \cdot {2}^{i} ! ) \cdot {\prod }_{m = min ( t )}^{max ( t )} m ! \cdot {\prod }_{j = min ( k )}^{max ( k )} ( {N}_{j} \cdot {N}_{j} ! ) . \qquad ( 6 )$$

Similar to the JPEG embodiment described above, in the case of video, the keys used for intra-level shifting the coefficients, as well as the keys used for intra-level shifting the motion vectors, may be changed dynamically. The overhead for transmitting the keys along with the encoded image data 518 is then:

$$T = {\sum }_{i = min ( l )}^{max ( l )} i + {\sum }_{j = min ( k )}^{max ( k )} ⌈ {log}_{2} \vert {k}_{j} \vert ⌉ . \qquad ( 7 )$$

It may be noted that, in the MPEG standard, the maximum value of kⱼ may be 28. While the scrambling table data may also be changed dynamically and transmitted to the decoder, less overhead is required if the scrambling table data is fixed and known a-priori at the decoder.

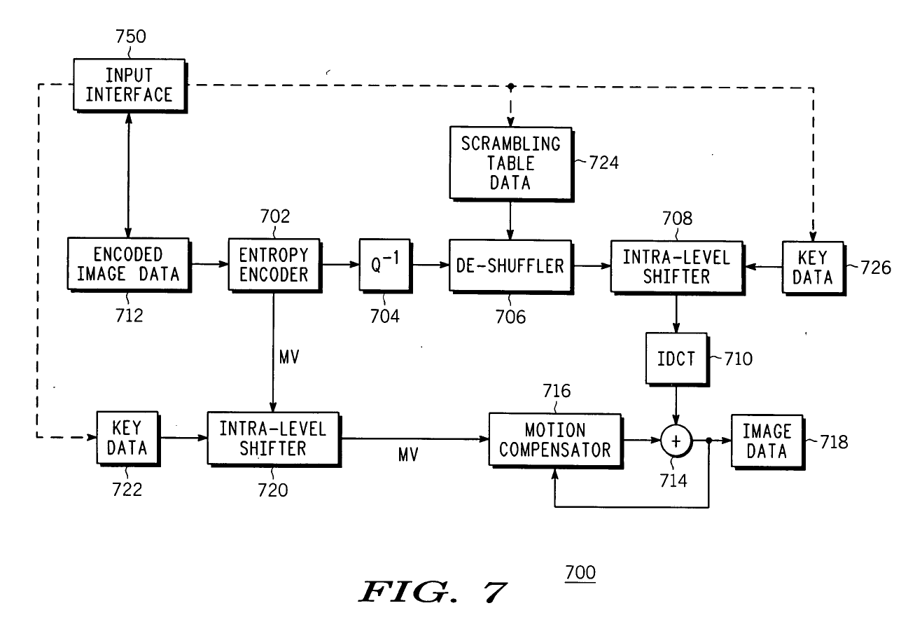

FIG. 7 is a block diagram depicting an exemplary embodiment of an MPEG compliant decoder 700 constructed in accordance with the invention. The decoder 700 is configured to process encoded image data 712 to recover image data 718. The decoder 700 comprises an entropy decoder 702, an inverse quantizer 704, a de-shuffler 706, an intra-level shifter 708, an IDCT unit 710, a summer 714, a motion compensator 716, an intra-level shifter 720, and an input interface 750. The input interface 750 is configured to provide encoded image data 712, as well as key data 722, scrambling table data 724, and/or key data 726, if such data is transmitted with the encoded image data 712. The entropy decoder 702 decodes the encoded image data 712 in a well known manner to produce motion vectors and quantized coefficients. The motion vectors are provided to the intra-level shifter 720. The intra-level shifter 720 uses the key data 722 associated with the encoded image data 712 to reverse the intra-level shifting that was performed by the intra-level shifter 516 of the encoder 500 of FIG. 5. The key data 722 may be received from the interface 750, or may be known a-priori at the intra-level shifter 720. The motion vectors processed by the intra-level shifter 720 are provided to the motion compensator 716. In particular, the intra-level shifter 720 using the inverse of Equation 5 used above in the encoder 500. The motion compensator 716 operates as described above with respect to the motion compensator 520 in the encoder 500 of FIG. 5.

The quantized coefficients are de-quantized by the inverse quantizer 704. The de-quantized coefficients are provided to the de-shuffler 706. The de-shuffler 706 uses the scrambling table data 724 associated with the encoded image data 712 to reverse the shuffling that was performed by the shuffler 510 in the encoder 500 of FIG. 5. The scrambling table data 724 may be received from the interface 750, or may be known a-priori at the de-shuffler 706. The coefficients processed by the de-shuffler 706 are provided to the intra-level shifter 708. The intra-level shifter 708 uses the key data 726 associated with the encoded image data 712 to reverse the intra-level shifting that was performed by the intra-level shifter 508 of the encoder 500 of FIG. 5. The key data 726 may be received from the interface 750, or may be known a-priori at the intra-level shifter 708. In particular, the intra-level shifter 708 using the inverse of Equation 5 used above in the encoder 500. The IDCT unit 710 translates the frequency domain coefficients to the pixel domain. The translated coefficients are combined with the output of the motion compensator 516 by the summer 714 to produce the image data 718.

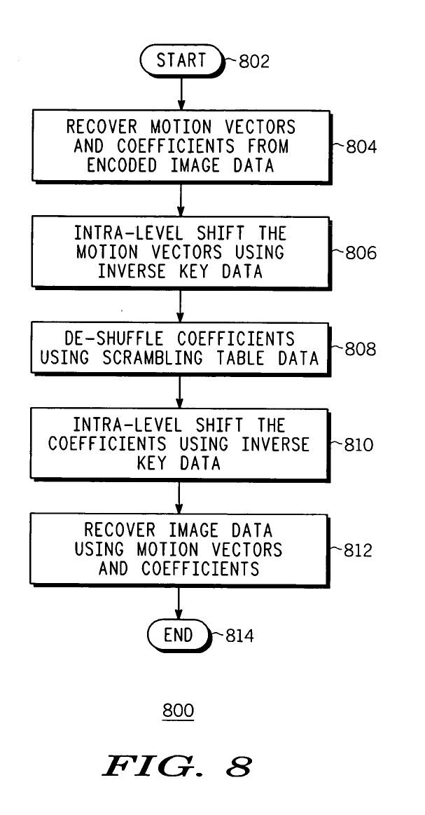

FIG. 8 is a flow diagram depicting an exemplary embodiment of a method 800 for decoding encoded image data using the decoder 700 of FIG. 7 in accordance with the invention. The method 800 begins at step 802. At step 804, motion vectors and coefficients are recovered from encoded image data. At step 806, the motion vectors are intra-level shifted using inverse key data. At step 808, the coefficients are de-shuffled using scrambling table data. At step 810, the coefficients are intra-level shifted using inverse key data. At step 812, the motion vectors and the coefficients are used to recover the image data. The method ends at step 814.

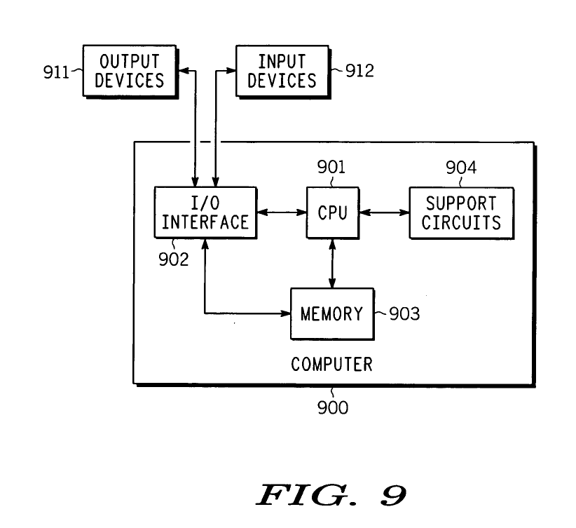

FIG. 9 is a block diagram depicting an exemplary embodiment of a computer 900 suitable for implementing the processes and methods described herein. The computer 900 includes a central processing unit (CPU) 901, a memory 903, various support circuits 904, and an I/O interface 902. The CPU 901 may be any type of microprocessor known in the art. The support circuits 904 for the CPU 901 include conventional cache, power supplies, clock circuits, data registers, I/O interfaces, and the like. The I/O interface 902 may be directly coupled to the memory 903 or coupled through the CPU 901. The I/O interface 902 may be coupled to various input devices 912 and output devices 911, such as a conventional keyboard, mouse, printer, display, and the like.

The memory 903 may store all or portions of one or more programs and/or data to implement the processes and methods described herein. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

The computer 900 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 903. The memory 903 may include one or more of the following random access memory, read only memory, magneto-resistive read/write memory, optical read/write memory, cache memory, magnetic read/write memory, and the like, as well as signal-bearing media as described below.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method of encoding image data, comprising:
frequency translating a set of samples associated with said image data to produce coefficients;
quantizing said coefficients;
shifting at least a first portion of said coefficients using first key data;
shuffling at least a second portion of said coefficients using scrambling table data; and
entropy coding said coefficients to produce encoded image data.

2. The method of claim 1, wherein said coefficients are organized into a plurality of levels, wherein said first key data includes a key for each of said plurality of levels, and wherein said step of shifting comprises, for each coefficient of said first portion of coefficients:
identifying a level of said plurality of levels for said coefficient;
adjusting a magnitude of said coefficient using said key associated with said identified level such that said coefficient remains in said identified level.

3. The method of claim 1, wherein said first portion of coefficients includes a DC coefficient.

4. The method of claim 1, wherein said second portion of coefficients includes at least one non-zero AC coefficient.

5. The method of claim 1, further comprising:
producing motion vectors from said image data; and
shifting said motion vectors using second key data.

6. The method of claim 5, wherein said motion vectors are organized into a plurality of levels, wherein said second key data includes a key for each of said plurality of levels, and wherein said step of shifting said motion vectors comprises, for each motion vector of said motion vectors:
identifying a level of said plurality of levels for said motion vector; and
adjusting a magnitude of said motion vector using said key associated with said identified level such that said motion vector remains in said identified level.

7. The method of claim 1, further comprising:
repeating said steps of frequency translating, quantizing, shifting, shuffling, and entropy coding for at least one additional set of samples associated with said image data.

8. The method of claim 7, further comprising:
dynamically adjusting at least one of said key data and said scrambling table data.

9. A method of decoding encoded image data, comprising:
entropy decoding said encoded image data to produce quantized coefficients;
obtaining first key data and scrambling table data associated with said encoded image data;
inverse quantizing said quantized coefficients to recover coefficients;
de-shuffling at least a first portion of said coefficients using said scrambling table data;
shifting at least a second portion of said coefficients using said first key data; and
frequency translating said coefficients to produce a set of image data samples.

10. The method of claim 9, wherein said coefficients are organized into a plurality of levels, wherein said first key data includes a key for each of said plurality of levels, and wherein said step of shifting comprises, for each coefficient of said second portion of coefficients:
identifying a level of said plurality of levels for said coefficient; and
adjusting a magnitude of said coefficient using said key associated with said identified level such that said coefficient remains in said identified level.

11. The method of claim 9, wherein said second portion of coefficients includes a DC coefficient.

12. The method of claim 9, wherein said first portion of coefficients includes at least one non-zero AC coefficient.

13. The method of claim 13, wherein said encoded image data is further entropy decoded to produce motion vectors, and wherein said method further comprises:
obtaining second key data associated with said encoded image data; and
shifting said motion vectors using second key data.

14. The method of claim 13, wherein said motion vectors are organized into a plurality of levels, wherein said second key data includes a key for each of said plurality of levels, and wherein said step of shifting said motion vectors comprises, for each motion vector of said motion vectors:
identifying a level of said plurality of levels for said motion vector;
adjusting a magnitude of said motion vector using said key associated with said identified level such that said motion vector remains in said identified level.

15. Apparatus for encoding image data, comprising:
a discrete cosine transform (DCT) unit for frequency translating a set of samples associated with said image data to produce coefficients;
a quantizer for quantizing said coefficients;
a first intra-level shifter for shifting at least a first portion of said coefficients using first key data;
a shuffler for shuffling at least a second portion of said coefficients using scrambling table data; and
an entropy encoder for entropy coding said coefficients to produce encoded image data.

16. The apparatus of claim 15, wherein said coefficients are organized into a plurality of levels, wherein said first key data includes a key for each of said plurality of levels, and wherein said first intra-level shifter is configured to, for each coefficient of said first portion of coefficients:
identify a level of said plurality of levels for said coefficient; and
adjust a magnitude of said coefficient using said key associated with said identified level such that said coefficient remains in said identified level.

17. The apparatus of claim 15, wherein said first portion of coefficients includes a DC coefficient.

18. The apparatus of claim 15, wherein said second portion of coefficients includes at least one non-zero AC coefficient.

19. The apparatus of claim 15, further comprising:
a motion estimator for producing motion vectors from said image data; and
a second intra-level shifter for shifting said motion vectors using second key data.

20. Apparatus for decoding encoded image data, comprising:
an entropy decoder for entropy decoding said encoded image data to produce quantized coefficients;
means for obtaining first key data and scrambling table data associated with said encoded image data;
an inverse quantizer for inverse quantizing said quantized coefficients to recover coefficients;
a de-shuffler for de-shuffling at least a first portion of said coefficients using said scrambling table data;
a first intra-level shifter for shifting at least a second portion of said coefficients using said first key data; and
an inverse discrete cosine transform (IDCT) unit for frequency translating said coefficients to produce a set of image data samples.

21. The apparatus of claim 20, wherein said coefficients are organized into a plurality of levels, wherein said first key data includes a key for each of said plurality of levels, and wherein said first intra-level shifter is configured to, for each coefficient of said second portion of coefficients:
identify a level of said plurality of levels for said coefficient; and
adjust a magnitude of said coefficient using said key associated with said identified level such that said coefficient remains in said identified level.

22. The apparatus of claim 20, wherein said second portion of coefficients includes a DC coefficient.

23. The apparatus of claim 20, wherein said first portion of coefficients includes at least one non-zero AC coefficient.

24. The apparatus of claim 20, wherein said entropy decoder is configured to recover motion vectors, and wherein said apparatus further comprises:
means for obtaining second key data associated with said encoded image data; and
a second intra-level shifter for shifting said motion vectors using second key data.

25. A computer readable carrier including program instructions that instruct a computer to perform a method of encoding image data, comprising:
frequency translating a set of samples associated with said image data to produce coefficients;
quantizing said coefficients;
shifting at least a first portion of said coefficients using first key data;
shuffling at least a second portion of said coefficients using scrambling table data; and
entropy coding said coefficients to produce encoded image data.

26. A computer readable carrier including program instructions that instruct a computer to perform a method of decoding encoded image data, comprising:
entropy decoding said encoded image data to produce quantized coefficients;
obtaining first key data and scrambling table data associated with said encoded image data;
inverse quantizing said quantized coefficients to recover coefficients;
de-shuffling at least a first portion of said coefficients using said scrambling table data;
shifting at least a second portion of said coefficients using said first key data; and
frequency translating said coefficients to produce a set of image data samples.
